(19) United States
(12) Patent Application Publication
(10) Pub. No.: US 2003/0209680 A1
(43) Pub. Date: Nov. 13, 2003

(54) Edge position detector

(75) Inventor: Vitaly Burkatovsky, Rishon LeZion (IL)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(73) Assignee: Creo IL. Ltd.

(21) Appl. No.: 10/141,978

(22) Filed: May 10, 2002

(51) Int. Cl. G01V 8/00; G01N 21/86

(52) U.S. Cl. 250/559.36

(57) ABSTRACT

Apparatus and method for precise detection of a leading edge of an object, such as printing plate. The printing plate penetrates a gap between a light source and a sensor. Detection is made when the amplified signal equals the peak signal divided by N, meaning 1/N of the sensor is covered by the plate.

### FIELD OF THE INVENTION

The present invention relates to a mechanism for edge detection of objects, and in particular to detecting a plate position during the process of plate exposure in a CTP device.

### BACKGROUND OF THE INVENTION

One of the goals of Computer To Plate (CTP) machines is to obtain a good quality of plate imaging, resulting in a good print quality. The quality of the final print depends, amongst others, on precise registration of the four color-separation images on the respective plates. This requires precise detection of the plate edge when it is mounted onto the plate-setters drum, or flatbed.

For this purpose, a high accuracy fiber optic sensor, for example, FS01 available from KEYENCE of NJ, US, can be used. The disadvantage of these sensors is in their relative high cost.

FIG. 1A is a block diagram representation of the most simple and cheap optical solution for edge detection, such as Slotted Optical Switch OPB120A, available from Optek Technology Inc., Texas. The detector consists of a light emitting diode (LED) 100, slots 190, optical sensor 110, amplifier 120 and Schmitt trigger 80, connected in series.

The detector of FIG. 1A operates in following mode:

In the standby stage, light from the LED 100 passes through the slots 190 of the detector and falls onto the sensor 110. Amplifier 120 amplifies the output signal of the sensor 110 up to the voltage Vamp, bigger than the Schmitt trigger 80 threshold. If Vamp exceeds the Schmitt trigger threshold, then the output signal Vst of the Schmitt trigger will be logic low.

FIG. 1B shows the amplifier 120 and Schmitt trigger 80 signals while plate 170 penetrates between the slots 190 of the detector. The X-axis shows the plate edge position. When plate 170 is outside the detector all the light from the LED falls onto the sensor, causing the amplifier output voltage Vamp1 to exceed the Schmitt trigger threshold voltage Vth (line3). At the position X1 the plate starts to cover some portion of the light and the value of signal Vamp1 (line 1) starts to decrease. At the moment when the plate reaches the position X2, Vamp1 crosses the value of the Schmitt trigger threshold and the Schmitt trigger output voltage Vst changes from low to high (line 4).

If, for some reason (for example temperature or LED current changes), the output of the amplifier 120 changes (for example increases—line 2), then at the plate position X2, Vamp will still exceed the Schmitt trigger threshold and only at position X3 Vamp drops below the Schmitt trigger threshold and the Schmitt trigger output voltage Vst changes from low to high (line 5).

Thus, it can be seen that changes in the LED current, or temperature, or power supply can lead to generation of the edge detection signal at different plate edge positions. In other words, changes in the LED current or temperature or power supply may lead to errors in plate edge detection.

There is a need for a low-cost detection mechanism that will be independent of those influences, to increase the precision of edge detection and improve the repeatability of the detectors.

### SUMMARY OF THE INVENTION

The present invention provides an apparatus and method for edge detection of an object, particularly a printing plate in a CTP device.

According to one aspect of the present invention there is provided an apparatus for edge detection of an object, comprising:

a current source;

a light source energized by said current source;

an optical sensor positioned at a distance from said light source, said optical sensor having a sensitive area receiving light from said light source;

an amplifier having an output, said amplifier receiving current from said sensor;

a peak detector connected with the output of said amplifier;

a voltage divider connected with an output of said peak detector, said voltage divider having a dividing factor N; and

a comparator having a first input connected with the output of said amplifier and a second input connected with said voltage divider,

wherein said light source illuminating said sensor, said object gradually penetrating the distance between said light source and said sensor, and said comparator outputting an edge detection signal when 1/N of the sensitive area of said sensor is shielded from the light by said object.

According to another aspect of the present invention there is provided a method of edge detection of an object, comprising the steps of:

providing a current source;

energizing a light source by said current source;

providing an optical sensor positioned at a distance from said light source, said optical sensor having a sensitive area receiving light from said light source;

amplifying signals from said sensor;

measuring a maximum signal of said amplified signals;

advancing said object between said light source and said sensor,

wherein the sensitive area of said sensor is gradually shielded from said light;

comparing said amplified signals with said maximum signal divided by N; and

repeating said steps of advancing and comparing until the signal from said amplifier equals said maximum signal divided by N.

According to another aspect of the present invention there is provided an apparatus for edge detection of an object, comprising:

a controlled current source;

a light source energized by said current source;

an optical sensor positioned at a distance from said light source, said optical sensor having a sensitive area receiving light from said light source;

an amplifier having an output, said amplifier receiving current from said sensor;

a peak detector connected with the output of said amplifier;

a voltage divider connected with an output of said peak detector, said voltage divider having a dividing factor N;

a first comparator having a first input connected with the output of said amplifier and a second input connected with said voltage divider;

a reference voltage source;

a second comparator connected with said output of said amplifier and with said reference voltage source; and

a logic circuit connected with an output of said second comparator and with said controlled current source,

wherein said logic circuit increases the current of the current source when receiving low voltage from said second comparator, said low voltage indicating amplified voltage level lower than the reference voltage,

wherein said light source illuminating said sensor, said object gradually penetrating the distance between said light source and said sensor, and said first comparator outputting an edge detection signal when 1/N of the sensitive area of said sensor is shielded from the light by said object.

According to another aspect of the present invention there is provided a method of edge detection of an object, comprising the steps of:

providing a controlled current source;

energizing a light source by said current source;

providing an optical sensor positioned at a distance from said light source, said optical sensor having a sensitive area receiving light from said light source;

amplifying signals from said sensor;

comparing said amplified signals to a reference signal, and if said amplified signal is lower than said reference signal, increasing the current of said controlled current source and repeating said steps of energizing, amplifying and comparing;

measuring a maximum signal of said amplified signals;

advancing said object between said light source and said sensor,

wherein the sensitive area of said sensor is gradually shielded from said light;

comparing said amplified signals with said maximum signal divided by N; and

repeating said steps of advancing and comparing until the signal from said amplifier equals said maximum signal divided by N.

### BRIEF DESCRIPTION OF THE DRAWINGS

FIG. 1A is a block diagram of an existing edge detection mechanism;

FIG. 1B shows the signals emitted by the mechanism of FIG. 1A at different plate positions;

FIG. 2 is a block diagram of an improved edge detector according to the present invention;

FIGS. 3A and 3B are signal diagrams showing the operation of the detector of FIG. 2 with different light intensities;

FIG. 4 shows the proportions of shadowed and energized areas of the sensor;

FIG. 5a shows sensor sensitivity per line segment of plate when the sensor axis is parallel to the plate axis;

FIG. 5b shows sensor sensitivity per line segment of plate when the sensor axis is at 45 degrees to the plate axis;

FIG. 6a shows the sensor current received while the plate-moving axis is parallel to the sensor axis;

FIG. 6b shows the sensor current received while the plate-moving axis is at 45 degrees to the sensor axis;

FIG. 7 is a block diagram of an edge detector including a coarse calibration mechanism, according to a second embodiment of the present invention; and

FIG. 8 is a schematic design of a peak detector useful in implementing the present invention.

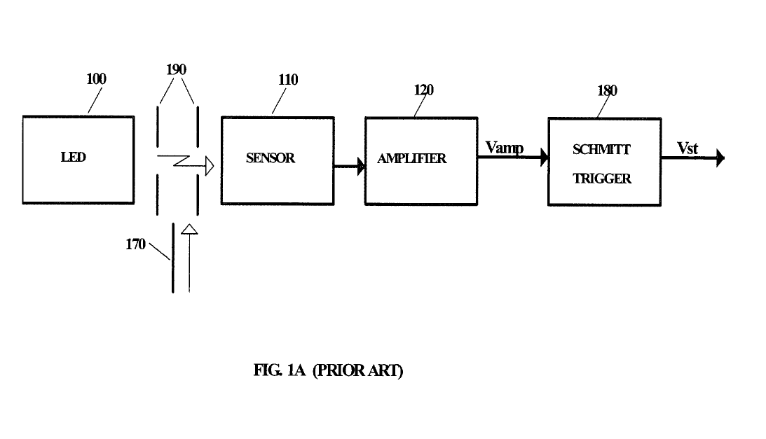

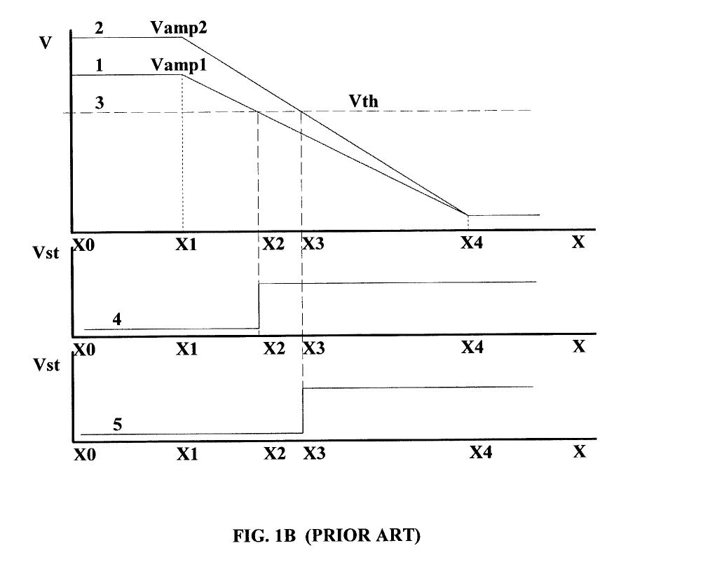

### DETAILED DESCRIPTION OF THE PRESENT INVENTION

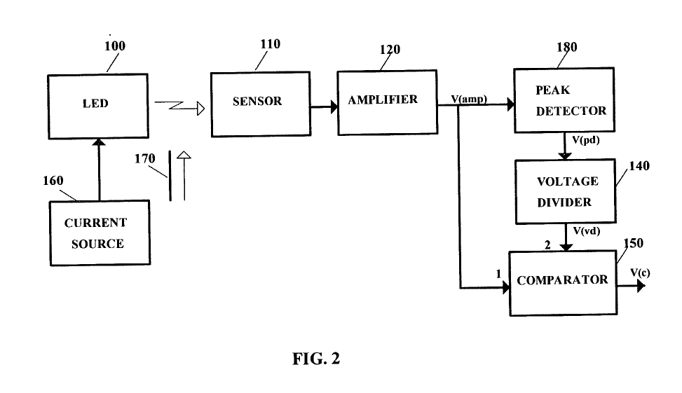

FIG. 2 is a block diagram of an improved edge detector according to the present invention. The edge detector consists of light emitting diode (LED) 100 (such as SFH484, available from Siemens, Germany) or another light source (such as incandescent lamp) and optical sensor 110 (such as SFH235, also available from Siemens), assembled opposite each other with a gap between them. Optical sensor 110 is connected to peak detector 130 input and to input-1 of comparator 150 through amplifier 120. Peak detector 130 output is connected to input-2 of comparator 150 through voltage divider 140. Light emitter 100 is energized by current source 160 connected to light emitter 100 input. Peak detector 130 can be implemented, for example, as shown in “An introduction to operational amplifiers with linear IC applications”, Luces M. Faulkenberry, Texas State Technical Institute, incorporated herein by reference. The schematic of such a peak detector is shown in FIG. 8.

In an alternative embodiment of the present invention, more than one optical sensor or multi-element photodiode array such as SLDA-61S10 of SILONEX may be used.

The device operates in following way:

After power up, current of the current source 160 causes the lighting of LED 100. This light falls onto the sensitive surface of sensor 110. The sensor signal, proportional to the light energy, is amplified by amplifier 120 and passed on to peak detector 130 and to input-1 of comparator 150. The output signal of peak detector 130, equal to the maximum of it's input, is sent to the voltage divider 140, and after being divided by voltage divider 140 is sent on to input-2 of comparator 150. In this position, the signal on input-1 of comparator 150 (coming directly from amplifier 120) is larger than the signal on input-2, thus the output V(c) of the comparator has voltage equal to logic zero.

As the plate begins to penetrate between the LED 100 and the sensor 110, it gradually shields the sensor 110 sensitive surface from the light emitted by the LED, causing the output signal of amplifier 120 to gradually decrease. At the same time, the output signal peak detector 130, divided by voltage divider 140—V(vd)—is still unchanged. When the output signal V(amp) of the amplifier reaches the level of the voltage divider 140 output, the comparator 150 output changes from logic zero to logic one.

The transition of comparator 150 output from low to high logic level indicates that plate 170 has covered 1/n of the sensitive surface of the sensor, where n is the dividing factor of voltage divider 140. If the coordinates of the sensor are known, the absolute coordinate of the plate edge can be found as 1/n of the sensor length added to the sensor position coordinate.

It can be shown that the performance of the mechanism, as described with respect to FIG. 2, is not dependent on current source, light emitter, sensor and amplifier parameters dispersion, thus increasing the accuracy and repeatability of the detector. The amplifier output voltage:

Va=E×Ka (1)

where:

E—Light energy delivered to the detector surface; and

Ka—Amplification coefficient (including Sensor sensitivity and Amplifier gain).

When the plate partially blocks the energy flow, the amplifier output voltage is:

Vap=E×Ka×(Se/S) (2)

where:

Se—Energized area of the sensor; and

S—Sensitive area of the sensor

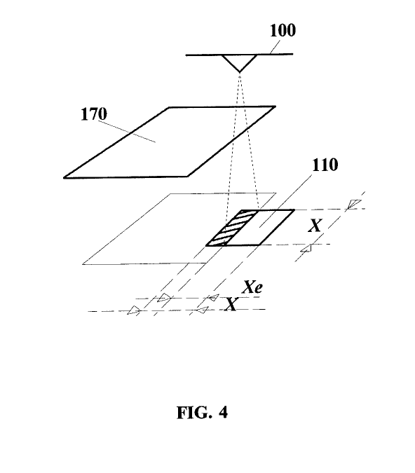

For a sensor of square shape (FIG. 4):

Se=Xe×X

S=X×X (3)

where

Xe—energized size of sensor in plate movement axis

X—length of sensor

Substituting (3) for (2) yields:

Vap=E×Ka×(Xe×X)/(X×X)=E×Ka×(Xe/X) (4)

From the comparator equation:

Vap=Vvd (5)

where:

Vvd—Voltage divider output

Or:

E×Ka×(Xe/X)=E×Ka/n (6)

where:

n—Voltage divider coefficient

This yields the position of comparator triggering:

Xe=X/n (7)

As can be seen, the comparator triggering is not dependent on either the light energy or the amplification coefficient. Equation (7) does not include a time parameter, meaning that the edge detection signal is not dependent on the plate penetration speed either.

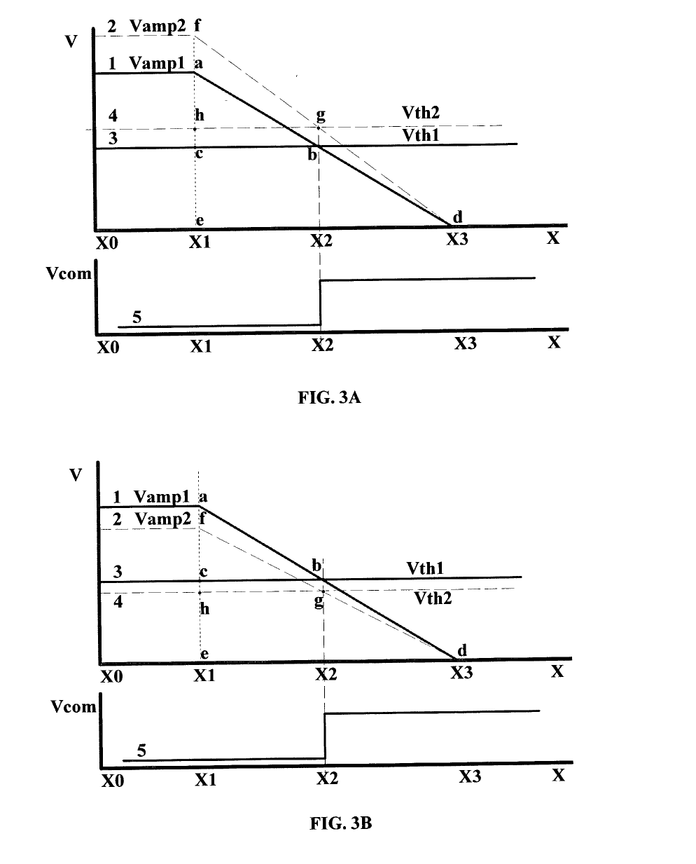

FIGS. 3A and 3B are signal diagrams showing the operation of the detector of FIG. 2 with different light intensities. The X-axis shows the plate edge position. Lines 1 and 3 show the initial signals on the comparator 150 inputs and line 5 show the signal on comparator 150 output, while plate 170 penetrates between the LED 100 and the sensor 110. Lines 2, 4 and 5 show the input and output signals of comparator 150, when some changes in light intensity take place.

When the plate 170 is outside the detector (position X0-X1), the output voltage Vamp1 (line 1) of amplifier 120 is high, due to the light energy falling onto the sensor 110. At the same time, the output voltage Vpd of peak detector 130 is equal to the input voltage Vpd in of the peak detector 130, and the output Vth1 of voltage divider 140 (line 3) is equal to Vpd out divided by n (For practical purposes the value of n may be chosen as n=2)

When the plate penetrates (position X1 to X3), the output voltage Vamp1 of amplifier 120 gradually decreases down to zero (full shadow).

For the similar triangles abc and ade:

ac/ae=ab/ad=cb/ed=1/n,

or, if n=2:

ac/ae=ab/ad=cb/ed=1/2

The plate edge detection signal (line 5) is generated by the comparator 150 when Vamp1=Vth1. As was shown, at this point

cb/ed=1/n,

and if n=2:

ed=2×cb, or X1X2=X2X3

This means that the plate edge detection signal is generated at the position ratio identical to the voltage divider coefficient n.

The peak detector 130 output should follow long term changes of amplifier output 120, while not being sensitive to short term changes, such as occur when the plate penetrates between the sensor 110 and the LED 100.

If, for some reason (for example temperature or current source 160 drift), the light intensity of LED 100 increases (FIG. 3A), the output of amplifier 120 will also be increase. In this case, the output voltage Vamp2 will start with a higher value than Vamp1 and will decrease to zero at plate position X3 (full shadow). In this case, the value stored in the peak detector represents an absolute maximum.

From the same analysis applied to similar triangles fgh and fde, it can be shown that

ed=2×hg, or X1X2=X2X3

This means that the plate edge detection signal is generated at the position ratio identical to the voltage divider coefficient n and is not dependent on long-term light changes.

If the light intensity of LED 100 slowly decreases (FIG. 3B), then the peak detector 130 will follow the amplifier output 120 due to the capacitor C (FIG. 8) leakage, or due to capacitor C discharge through the optional resistor R. Time constant T=RC should be large enough to maintain the peak detector output practically unchanged during the short time of the plate penetration between the LED and the sensor. In this case, the value stored in the peak detector represents the amplifier output just prior to the plate penetration, thus representing a local maximum over a short period of time.

In this case, the output voltage Vamp2 will start with a lower value than Vamp1 and will decrease to zero at plate position X3 (full shadow). Applying the above analysis it can be seen that the plate edge detection signal is generated at the same position X2 of the plate, equal to half of the distance (X3-X1 ).

The higher accuracy of the detector can be obtained due to the sensor position relative to the plate movement axis.

The sensor current is defined by

Is=W×K×S (1)

where

W is the light energy per area unit;

K is the sensor coefficient; and

S is the lighted part of the sensitive surface.

The sensitivity of the sensor per line segment will be

Z=dIs/dX (2)

Taking into consideration equation 1 and assuming that the energy flow is constant, we can see that the maximum sensitivity per line segment will be defined by

dS/dX

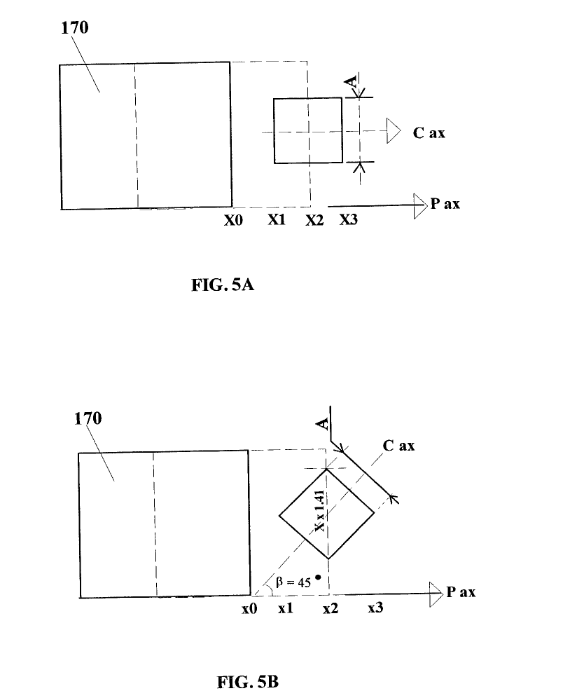

In FIG. 5A, the plate axis Pax is parallel to the sensor chip axis Cax and the photosensitive area of the chip has a square shape with side A.

The plate moves across along the Pax axis. While moving, similar line segments of the plate 170 shield similar areas of the sensor sensitive area, due to the square shape of the sensor.

In FIG. 5B, the sensor is rotated by 45 degrees relative to the plate axis Pax. Now, while moving, similar line segment of the plate 170 shield increasing areas of the sensor sensitive area up to position X2 and shield decreasing areas of the sensor sensitive area between positions X2 and X3. As can be seen from FIG. 5B, the maximum of shielded area per line segment is at the point X2.

It can be shown that the sensor sensitivity per line segment, in position X2 in the configuration of FIG. 5B is greater than that of the configuration of FIG. 5A, by a factor of 1.41 (SQRT 2).

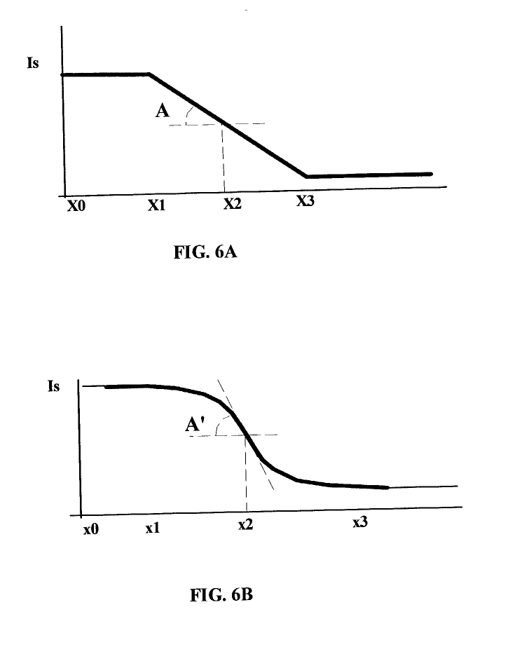

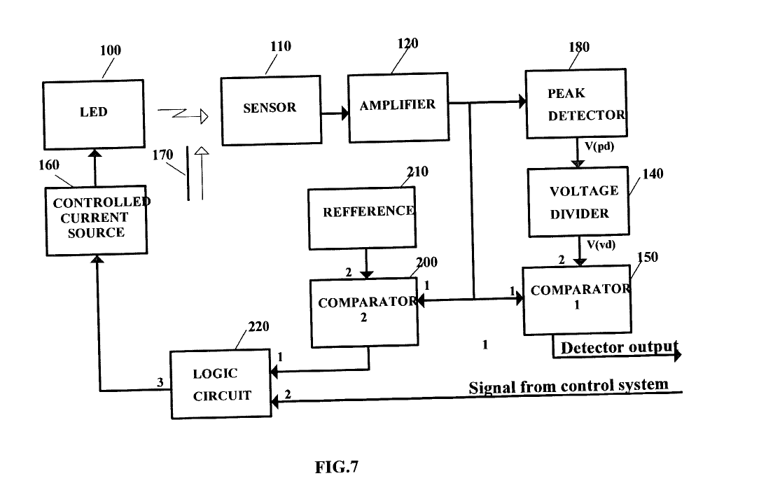

FIG. 6A shows the sensor current received while the plate 170 penetrates between sensor and detector, with the sensor axis parallel to the plate-moving axis.

FIG. 6B shows the sensor current received while the plate 170 penetrates between sensor and detector, with the sensor axis rotated by 45 degrees relative to the plate-moving axis.

Comparing FIGS. 6A and 6B shows that angle A (sensitivity of the sensor per line segment when parallel axes) is smaller than angle A′ (sensitivity of the sensor per line segment when sensor axis is rotated). Better sensitivity improves the accuracy of the sensor.

The detector described in FIG. 2 is accurate within the relatively small changes of the light caused by, for example, temperature drift, or LED current deviation within the current source tolerances. There are, however, other factors that can cause larger changes in the light falling onto the sensor. For example:

1. Inaccurate positioning of the LED relative to the photo sensor (caused, for example, during assembly or by vibration shifts).

2. Contamination of the sensor by, for example, dust.

If a significant (20%-50%) light degradation occurs, the detector of FIG. 2 will still function, but it's sensitivity and accuracy will be reduced.

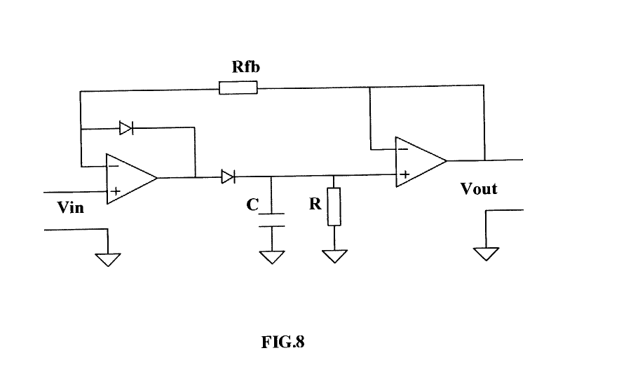

FIG. 7 is a block diagram of another embodiment of the edge detector of the present invention, which overcomes this disadvantage by implementing a coarse calibration feature. The device of FIG. 7 is similar to the device of FIG. 2, but has some additional functional blocks: A second comparator 200, connected with it's input-1 to the output of amplifier 120, with it's input-2 to the a reference voltage source 210 and with it's output to input-1 of a logic circuit 220. Input-2 of logic circuit 220 serves for a start signal of the coarse calibration. Such a signal can be obtained, for example, from a higher-level control system. Reference voltage source 210 produces a constant predefined voltage, equal to the output signal of amplifier 120 while the current of the LED 100 is nominal and the plate is outside the detector.

The light of LED 100 is controlled by the logic circuit (output-3) through the controlled current source 160.

In an alternative embodiment of the present invention, more than one optical sensor or multi-element photodiode array such as SLDA-61S10 of SILONEX may be used.

The detector of FIG. 7 operates in following way:

After power up, or when a ‘start coarse calibration signal’ is received, the logic circuit generates on it's output-3 a command for minimum current of current source 160, which causes the minimum lighting of LED 100. The output signal of amplifier 120 is relatively low, due to minimum energy falling onto the sensor from LED 100.

In this situation, the signal on the input-1 of second comparator 200 is smaller than the signal on input-2 (reference) and the second comparator output has a low logic level. Logic circuit 220 performs periodical checks of the value of second comparator output on its input-1 and if this signal is low, logic circuit 220 increases the light emitting diode current by command from its output-3. This process continues up to the moment when the amplifier output signal becomes equal to the reference value. When this happens, the output signal of the second comparator 200 jumps from low to high value and logic circuit 220 ceases to increase the LED current.

If, for example, the light energy falling onto the sensor was decreased by dust contamination, then after initializing the coarse calibration process, the LED current will be increased by the logic circuit up to the level high enough to raise the output of the amplifier to the value equal to the reference. In other words, the increase of the LED current will compensate for the loss of light energy caused by the dust and the detector's sensitivity will not change.

While the apparatus and method of the present invention have been described with reference to plate edge detection in a CTP device, it will be apparent to any person skilled in the art that the apparatus and method of the present invention lend themselves to any application requiring precise edge detection, and are only limited by the claims that follow.

What is claimed:

1. Apparatus for edge detection of an object, comprising:
a current source;
a light source energized by said current source;
an optical sensor positioned at a distance from said light source, said optical sensor having a sensitive area receiving light from said light source;
an amplifier having an output, said amplifier receiving current from said sensor;
a peak detector connected with the output of said amplifier;
a voltage divider connected with an output of said peak detector, said voltage divider having a dividing factor N; and
a comparator having a first input connected with the output of said amplifier and a second input connected with said voltage divider,
wherein said light source illuminating said sensor, said object gradually penetrating the distance between said light source and said sensor, and said comparator outputting an edge detection signal when 1/N of the sensitive area of said sensor is shielded from the light by said object.

2. The apparatus of claim 1, wherein said light source is a light emitting diode.

3. The apparatus of either of claims 1, wherein said object is a printing plate.

4. The apparatus of claim 1, wherein said optical sensor comprises multiple sensitive surfaces.

5. The apparatus of claim 1, wherein said sensor is positioned at an angle to the axis of said object penetration.

6. Apparatus for edge detection of a printing plate in a computer to plate device, comprising:
a current source;
a light source energized by said current source;
an optical sensor positioned at a distance from said light source, said optical sensor having a sensitive area receiving light from said light source;
an amplifier having an output, said amplifier receiving current from said sensor;
a peak detector connected with the output of said amplifier;
a voltage divider connected with an output of said peak detector, said voltage divider having a dividing factor N; and
a comparator having a first input connected with the output of said amplifier and a second input connected with said voltage divider,
wherein said light source illuminating said sensor, said printing plate gradually penetrating the distance between said light source and said sensor, and said comparator outputting an edge detection signal when 1/N of the sensitive area of said sensor is shielded from the light by said printing plate.

7. The apparatus of claim 6, wherein said optical sensor comprises multiple sensitive surfaces.

8. The apparatus of claim 6, wherein said sensor is positioned at an angle to the axis of said object penetration.

9. A method of edge detection of an object, comprising the steps of:
providing a current source;
energizing a light source by said current source;
providing an optical sensor positioned at a distance from said light source, said optical sensor having a sensitive area receiving light from said light source;
amplifying signals from said sensor;
storing a representative value of said amplified signals;
advancing said object between said light source and said sensor, wherein the sensitive area of said sensor is gradually shielded from said light;
comparing amplified signals received from said sensor during said step of advancing with said stored signal divided by N; and
repeating said steps of advancing and comparing until the signal from said amplifier equals said maximum signal divided by N.

10. The method of claim 9, wherein said light source is a light emitting diode.

11. The method of either of claim 9, wherein said object is a printing plate.

12. The method of claim 9, wherein said optical sensor comprises multiple sensitive surfaces.

13. The method of claim 9, wherein said sensor is positioned at an angle to the axis of said object penetration.

14. The method of claim 9, wherein said representative value is an absolute maximum of said amplified signals.

15. The method of claim 9, wherein said representative value is a local maximum of said amplified signals.

16. A method of edge detection of a printing plate in a computer to plate device, comprising the steps of:
providing a current source;
energizing a light source by said current source;
providing an optical sensor positioned at a distance from said light source, said optical sensor having a sensitive area receiving light from said light source;
amplifying signals from said sensor;
measuring a maximum signal of said amplified signals;
advancing said printing plate between said light source and said sensor, wherein the sensitive area of said sensor is gradually shielded from said light;
comparing said amplified signals with said maximum signal divided by N; and
repeating said steps of advancing and comparing until the signal from said amplifier equals said maximum signal divided by N.

17. The method of claim 16, wherein said optical sensor comprises multiple sensitive surfaces.

18. The method of claim 16, wherein said sensor is positioned at an angle to the axis of said object penetration.

19. Apparatus for edge detection of an object, comprising:
a controlled current source;
a light source energized by said current source;
an optical sensor positioned at a distance from said light source, said optical sensor having a sensitive area receiving light from said light source;
an amplifier having an output, said amplifier receiving current from said sensor;
a peak detector connected with the output of said amplifier;
a voltage divider connected with an output of said peak detector, said voltage divider having a dividing factor N;
a first comparator having a first input connected with the output of said amplifier and a second input connected with said voltage divider;
a reference voltage source;
a second comparator connected with said output of said amplifier and with said reference voltage source; and
a logic circuit connected with an output of said second comparator and with said controlled current source,
wherein said logic circuit increases the current of the current source when receiving low voltage from said second comparator, said low voltage indicating amplified voltage level lower than the reference voltage,
wherein said light source illuminating said sensor, said object gradually penetrating the distance between said light source and said sensor, and said first comparator outputting an edge detection signal when 1/N of the sensitive area of said sensor is shielded from the light by said object.

20. The apparatus of claim 19, wherein said light source is a light emitting diode.

21. The apparatus of claim 19, wherein said object is a printing plate.

22. The apparatus of claim 19, wherein said sensor is positioned at an angle to the axis of said object penetration.

23. The apparatus of claim 19, wherein said optical sensor comprises multiple sensitive surfaces.

24. Apparatus for edge detection of a printing plate in a computer to plate device, comprising:
a controlled current source;
a light source energized by said current source;
an optical sensor positioned at a distance from said light source, said optical sensor having a sensitive area receiving light from said light source;
an amplifier having an output, said amplifier receiving current from said sensor;
a peak detector connected with the output of said amplifier;
a voltage divider connected with an output of said peak detector, said voltage divider having a dividing factor N;
a first comparator having a first input connected with the output of said amplifier and a second input connected with said voltage divider;
a reference voltage source;
a second comparator connected with said output of said amplifier and with said reference voltage source; and
a logic circuit connected with an output of said second comparator and with said controlled current source,
wherein said logic circuit increases the current of the current source when receiving low voltage from said second comparator, said low voltage indicating amplified voltage level lower than the reference voltage,
wherein said light source illuminating said sensor, said printing plate gradually penetrating the distance between said light source and said sensor, and said first comparator outputting an edge detection signal when 1/N of the sensitive area of said sensor is shielded from the light by said printing plate.

25. A method of edge detection of an object, comprising the steps of:
providing a controlled current source;
energizing a light source by said current source;
providing an optical sensor positioned at a distance from said light source, said optical sensor having a sensitive area receiving light from said light source;
amplifying signals from said sensor;
comparing said amplified signals to a reference signal, and if said amplified signal is lower than said reference signal, increasing the current of said controlled current source and repeating said steps of energizing, amplifying and comparing;
measuring a maximum signal of said amplified signals;
advancing said object between said light source and said sensor, wherein the sensitive area of said sensor is gradually shielded from said light;
comparing said amplified signals with said maximum signal divided by N; and
repeating said steps of advancing and comparing until the signal from said amplifier equals said maximum signal divided by N.

26. The method of claim 25, wherein said light source is a light emitting diode.

27. The method of claim 25, wherein said object is a printing plate.

28. The method of claim 25, wherein said optical sensor comprises multiple sensitive surfaces.

29. The method of claim 25, wherein said sensor is positioned at an angle to the axis of said object penetration.

30. A method of edge detection of printing plate in a computer to plate device, comprising the steps of:
providing a controlled current source;
energizing a light source by said current source;
providing an optical sensor positioned at a distance from said light source, said optical sensor having a sensitive area receiving light from said light source;
amplifying signals from said sensor;
comparing said amplified signals to a reference signal, and if said amplified signal is lower than said reference signal, increasing the current of said controlled current source and repeating said steps of energizing, amplifying and comparing;
measuring a maximum signal of said amplified signals;
advancing said printing plate between said light source and said sensor, wherein the sensitive area of said sensor is gradually shielded from said light;
comparing said amplified signals with said maximum signal divided by N; and
repeating said steps of advancing and comparing until the signal from said amplifier equals said maximum signal divided by N.
